(19) United States
(12) Patent Application Publication
(10) Pub. No.: US 2025/0091669 A1
(43) Pub. Date: Mar. 20, 2025

(54) Climbing Robot

(71) Applicants: University of Leeds, Leeds (GB); Acuity Robotics Limited, Leeds (GB)

(72) Inventors: Jason Liu, Leeds (GB); Jake Smith, Leeds (GB); Robert Richardson, Leeds (GB)

(21) Appl. No.: 18/855,740

(22) PCT Filed: Apr. 6, 2023
(86) PCT No.: PCT/GB2023/050936

§ 371 Date: Oct. 10, 2024

(30) Foreign Application Priority Data
Apr. 11, 2022 (GB) 2205312.8

(51) Int. Cl. B62D 57/024; B60B 19/00; B62D 21/14

(52) U.S. Cl. CPC B62D 57/024; B60B 19/006; B62D 21/14

(57) ABSTRACT

The present application discloses a climbing robot (10) for climbing ferrous structures (30), a dual gear pivot mechanism for a climbing robot (10), and a method of controlling a climbing robot (10) for climbing ferrous structures (30). The climbing robot (10) comprises three drive units (12, 14, 16) coupled together and the central drive unit is coupled to a pivot mechanism (24). Each drive unit (12, 14, 16) comprises a wheel arrangement (13, 15, 17) comprising at least one wheel configured to adhere to a ferrous tower (30), and each wheel is independently controllable. A first wheel arrangement (13) is the wheel arrangement of one of the three drive units (12, 14, 16). A second wheel arrangement (15) is the wheel arrangement of another one of the three drive units (12, 14, 16). The pivot mechanism (24) is arranged to change the average distance between the first and second wheel arrangements (13, 15) in response to movement, about a point of the pivot mechanism (24) by an angle, of the two end drive units (12, 16) with respect to each other.

### FIELD OF THE INVENTION

The present invention relates to vehicles and robots Specifically, a climbing robot for climbing ferrous structures.

### BACKGROUND OF THE INVENTION

Structures such as towers, and more specifically, mono-poled masts, wind turbine towers, overhead gantries, bridges, power line towers, general ducting, and more generally ferrous structures, are commonly found types of infrastructure. For example, mono-poled masts are common critically essential infrastructure in a modern digitally connected world, used for supporting antennas and electronic communications equipment.

Inspecting such structures (which can be up to 30 meters tall) can be dangerous and challenging. Some structures can be climbed with professionally trained human riggers however others require large external tools such as bucket lifts. Human workers operating at height presents a risk to their own safety, despite stringent risk assessments aimed at minimising this risk. Therefore, there is a need to either reduce time operating at height or to remotely perform tasks at height, for example, with climbing robots or drones.

Climbing robots typically depend on some form of adhesion to the structure. Such adhesion may be achieved in a number of ways, for example, using permanent magnets or electromagnets, negative pressure mechanisms using vacuum pumps and suction cups, and electro-adhesion (such as, electrostatic induction). Each adhesion mechanism has its own unique benefits and ability to cope with obstacles (e.g. bands which are commonly found on real world structures to attach signage or external cabling) that are detrimental to maintaining adhesion, so the ability to overcome obstacles present on a real-world tower structure is necessary for the operation of a robot.

In particular, if the tower is ferrous then a climbing robot which uses magnetic adhesion at a number of tower contact points is preferable. However, when an obstacle is encountered (particularly if the obstacle is non-ferrous) then adhesion can be lost when the climbing robot attempts to overcome the obstacle due to a reduced number of contact points with the tower.

### SUMMARY OF THE INVENTION

By way of a non-limiting example the climbing robot as described herein can climb monopole mast structures without a tether and can be operated remotely from ground level. The magnetic adhesion between robot and structure is supplied using permanent magnets. Wheel contact with the structure is maintained using a five degree of freedom (5DOF) linkage coupling together three individual drive units (each with 2 independently driven wheels). For the climbing robot to adapt to the surface curvature of a cylindrical monopole mast's exterior and still allow for steering, the 5DOF linkage mechanism is arranged to offer degrees of freedom in the order roll—yaw—pitch—yaw—roll along the length of the three individual drive units between the front and back. The roll joints are located at the front and rear drive units and a pitch joint is located in-between at the middle drive unit, such that between each of the three drive units is a yaw joint. When climbing over a small step or non-ferrous band, the first set of wheels of the front drive unit will be prone to detaching, leading to the loss of adhesion to the front drive unit. To passively reattach the front wheels to the structure and restore adhesion after the front drive unit passes the obstacle, elastic material between the front and rear drive modules constantly supplies a rotational counter force at the pitch joint which passively pushes the front and rear drive units towards the climbing surface. The pitch joint (located at the middle drive unit) is composed of a dual spur gear mechanism which can maintain an equal angle of the middle drive unit in respect to the front and rear drive units. An equal angle enables maximum maneuverability. Additionally, an optional payload may be mounted to the rear drive unit which shifts the center of mass to the rear of the climbing robot, i.e., closest point to the ground, which passively assists in stable adhesion to monopole masts and reduces the risk of wheel slippage. Once the front drive unit has passed the obstacle and adhesion is restored, the middle then rear drive units can tackle the same obstacle with at least two other drive units always maintaining the climbing robot's adhesion to the structure.

A first aspect of the invention provides a climbing robot for climbing ferrous structures, comprising: a first drive unit, a second drive unit coupled to a pivot mechanism, and a third drive unit. The second drive unit is coupled to the first and third drive units. Each of the first, second, and third drive units comprise a wheel arrangement comprising at least one wheel configured to adhere to a ferrous tower, and each wheel is independently controllable. A first wheel arrangement is the wheel arrangement of one of the first, second, and third drive units, and a second wheel arrangement is the wheel arrangement of another one of the first, second, and third drive units. The pivot mechanism is arranged to change the average distance between the first and second wheel arrangements in response to movement, about a point of the pivot mechanism by an angle, of the first and third drive units with respect to each other.

Thus, the first aspect of the invention provides a climbing robot which has a reduced weight, increased flexibility, and reduced complexity.

The pivot mechanism may be a dual gear pivot mechanism comprising two partially-circular elements arranged to couple at a pitch point, and the point of the pivot mechanism may be the pitch point of the dual gear pivot mechanism.

The pivot point of each of the two partially-circular elements may be fixed relative to the second drive unit.

The first wheel arrangement may be the wheel arrangement of one of the first and third drive units. The second wheel arrangement may be the wheel arrangement of the second drive units. The change in the average distance between the first and second wheel arrangements may be an increase in the average distance between the first and second wheel arrangements.

The first wheel arrangement may be the wheel arrangement of the first drive unit. A third wheel arrangement may be the wheel arrangement of the third drive unit. The pivot mechanism may be arranged to decrease the average distance between the first and third wheel arrangements in response to movement about the point of the pivot mechanism by an angle, of the first and third drive units with respect to each other.

The first wheel arrangement may be the wheel arrangement of the first drive unit. The second wheel arrangement may be the wheel arrangement of the third drive unit. The change in the average distance between the first and second wheel arrangements may be a decrease in the average distance between the first and second wheel arrangements.

The first drive unit and the second drive unit may be coupled in order to allow the first drive unit and the second drive unit to yaw and roll with respect to each other.

The second drive unit and the third drive unit may be coupled so to allow the second and third drive units to yaw and roll with respect to each other.

The wheel arrangement of the first, second, and third drive units may comprise two wheels.

The climbing robot of the first aspect may further comprise a restoration-force arrangement configured to bias at least one of the wheel arrangements to a surface of a ferrous tower.

The restoration-force may be an elastic material.

The restoration-force arrangement may be an elastic material which passes across the point of the pivot mechanism.

The centre of mass of the climbing robot may be off-centre, for example, towards the third drive unit (that is, the drive unit that is towards the rear and closest to the ground during climbing).

The third drive unit may comprise the power source for the climbing robot. Locating the power source in the third drive unit may help to shift the centre of mass towards the third drive unit.

Each wheel may comprise permanent magnets to adhere to a ferrous structure.

The climbing robot of the first aspect may further comprise a controller configured to control the wheels of the first wheel arrangement and the wheels of the second wheel arrangement to change the average distance between the first and second wheel arrangements The pivot mechanism may be arranged to cause the first and third drive units to move with respect to each other about a point of the pivot mechanism by an angle, in response to the change in the average distance between the first and second wheel arrangements.

A second aspect of the invention provides a dual gear pivot mechanism for a climbing robot comprising a first arm comprising: a first partially-circular element at a distal end of the first arm, and a first coupling end configured to couple to a first drive unit of a climbing robot. The dual gear pivot mechanism also comprises a second arm comprising: a second partially-circular element at a distal end, and a second coupling end configured to couple to a third drive unit of a climbing robot. The first partially-circular element and the second partially-circular element are arranged to connect with each other to form a pitch point and each comprise a respective pivot point. Each pivot point is coupled to a second drive unit of a climbing robot such that the pivot points are fixed relative to each other. The first and second arms are arranged to pivot about the respective pivot points.

The first and second arms may be arranged to move about the pitch point symmetrically.

The first arm may further comprise a first connection point arranged to connect to an elastic material. The second arm may further comprise a second connection point arranged to connect to the elastic material. The elastic material may be coupled between the first and second connection points and arranged to bias the pitch point.

A third aspect of the invention provides a method of controlling a climbing robot for climbing ferrous structures, the climbing robot comprising: a first drive unit, a second drive unit coupled to a pivot mechanism, and a third drive unit. The second drive unit is coupled to the first and third drive units. Each of the first, second, and third drive units comprise a wheel arrangement comprising at least one wheel configured to adhere to a ferrous tower. Each wheel is independently controllable. The method comprising: operating a first wheel arrangement and a second wheel arrangement to change the average distance between the first and second wheel arrangements, to cause the first and third drive units to move with respect to each other about a point of the pivot mechanism by an angle. The first wheel arrangement is the wheel arrangement of one of the first, second, and third drive units. The second wheel arrangement is the wheel arrangement of another one of the first, second, and third drive units.

Each wheel arrangement of the first, second, and third drive units may comprise two wheels. The method may further comprise operating both wheels of one of the first, second, and third drive units independently to turn the climbing robot.

### BRIEF DESCRIPTION OF THE DRAWINGS

Embodiments of the invention will now be described, by way of example only, with reference to the accompanying drawings, in which:

FIG. 1 shows a view of a climbing robot.

FIG. 2 shows another view of the climbing robot of FIG. 1.

FIG. 3 shows another view of the climbing robot of FIG. 1.

FIG. 4 shows another view of the climbing robot of FIG. 1.

FIGS. 5a-5k are a time-sequential series which show the side view of the climbing robot of FIG. 1 overcoming an obstacle.

FIG. 6 shows a side view of the climbing robot of FIG. 1 without a central drive unit.

FIG. 7 shows a dual gear pivot mechanism and couplers.

FIG. 8a shows a climbing robot turning.

FIG. 8b shows a top view of the climbing robot of FIG. 8a turning.

FIG. 9 shows a climbing robot twisting.

FIG. 10a shows a climbing robot conforming to the surface of a ferrous tower.

FIG. 10b shows another view of the climbing robot of FIG. 10a conforming to the surface of a ferrous tower.

FIG. 11 shows a cross section through a climbing robot.

FIG. 12 shows a cross section of the climbing robot i with a first drive unit pivoted.

FIG. 13 shows a block diagram of a computer system which can be used to control a climbing robot.

### DETAILED DESCRIPTION OF EMBODIMENT(S)

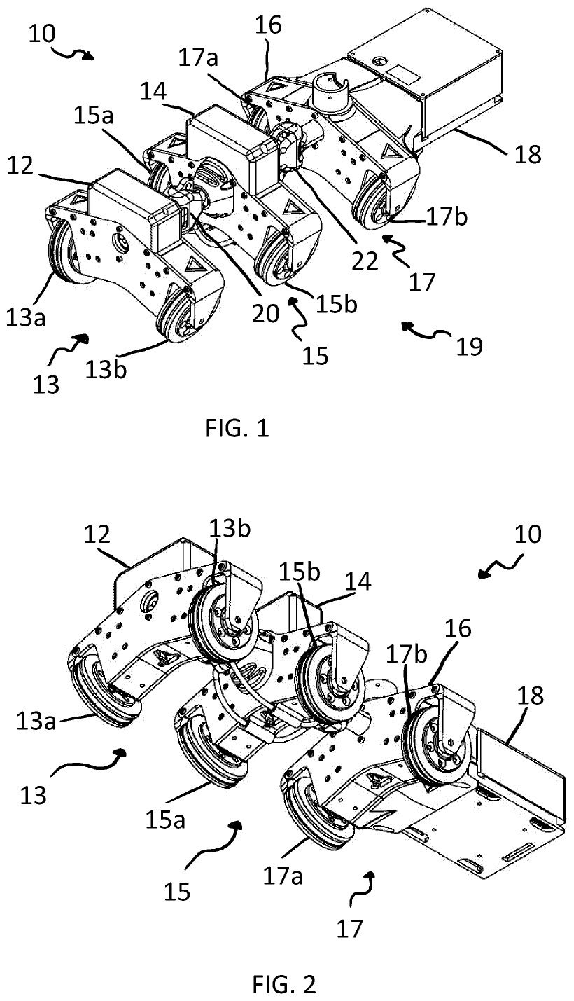

With reference to FIGS. 1 to 5k, and 8a to 12, a climbing robot 10 is shown. The climbing robot 10 is for climbing ferrous structures, such as towers, although its design may have many other uses. The climbing robot 10 has many adaptations which make it particularly suited to the task of climbing ferrous structures which will be described herein.

FIGS. 1 and 2 show the climbing robot 10 comprising three coupled drive units: a first drive unit 12, a second drive unit 14, and a third drive unit 16. Coupling means 20 between the first drive unit 12 and the second drive unit 14, and coupling means 22 between the second drive unit 14 and the third drive unit 16 enable a high degree of flexibility which allows the climbing robot 10 to conform to unevenly shaped surfaces, such as those found on ferrous towers. Each coupling means may be a flexible coupling means with at least one degree of freedom. In use, the climbing robot 10 can ascend a ferrous tower with the first drive unit 12 leading, such that the third drive unit 16 is closest to the base of the ferrous tower.

The first drive unit 12 has a wheel arrangement of two independently controllable wheels: a first right hand (RH) wheel 13a, and a first left hand (LH) wheel 13b. The second drive unit 14 has a wheel arrangement of two independently controllable wheels: a first RH wheel 15a, and a first LH wheel 15b. The third drive unit 16 has a wheel arrangement of two independently controllable wheels: a first RH wheel 17a, and a first LH wheel 17b.

Each wheel of the climbing robot 10 is configured to magnetically adhere to a ferrous tower by permanent magnets located in the wheels. Permanent magnets are advantageous because they are a passive means of magnetic adhesion. This improves reliability when climbing ferrous towers. In addition, permanent magnets do not require an additional power supply and thus enable the climbing robot 10 to be simpler and lighter in weight (since batteries, when used as a power supply, contribute weight to the climbing robot 10). In the example shown, all wheels of the climbing robot 10 are of the same size, although in an alternative embodiment wheels may be of differing sizes.

A controller of the climbing robot 10 can control each wheel 13a, 13b, 15a, 15b, 17a, 17b of the climbing robot independently. That is, the speed of each of the wheels 13a, 13b, 15a, 15b, 17a, and 17b in a forwards and reverse direction can be individually set, including setting any of the wheels 13a, 13b, 15a, 15b, 17a, and 17b to zero speed (i.e., braking). The independent control of the wheels of the climbing robot 10 enables the manoeuvrability of the climbing robot 10, for example, allowing the climbing robot 10 to steer around obstacles on the tower.

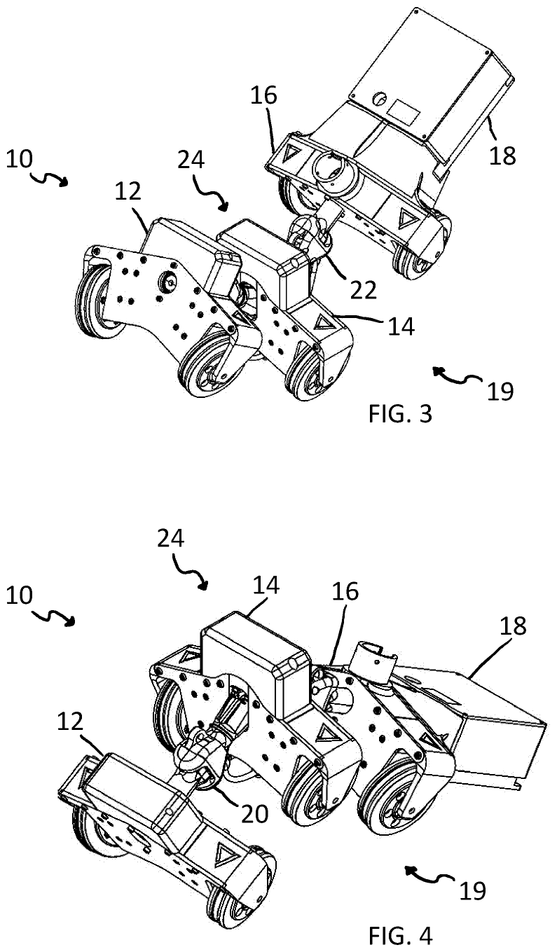

FIGS. 3 and 4 show the climbing robot 10 in an upward flexed position and a downward flexed position. A five degree of freedom (5DOF) linkage 19 couples the first, second, and third drive units 12, 14, 16 together to enable the climbing robot 10 to have a high degree of flexibility so that wheels may conform to the surface (e.g., a cylindrical surface) of the ferrous tower. The 5DOF linkage 19 also allows the climbing robot 10 to reach over obstacles and perform complex manoeuvres such as a spiral search pattern when climbing up a cylindrical or otherwise curved/uneven surfaced tower, which would not be possible with a rigid six wheeled frame. In alternative examples, other means of coupling the first, second, and third drive units 12, 14, 16 together which enable the desired flexibility are possible and known to provide suitable flexibility (these coupling means may be powered/active, or unpowered/passive).

The 5DOF linkage 19 comprises a pivot mechanism 24 which is coupled to the second drive unit 14. The pivot mechanism 24 is arranged to provide one degree of freedom: pitch. The pivot mechanism 24 allows the first and third drive units 12, 16 to move with respect to each other about a point of the pivot mechanism 24 by an angle, as shown in FIGS. 3 and 4.

As discussed in relation to FIGS. 1 and 2, a first wheel arrangement 13 comprises the first RH wheel 13a and the first LH wheel 13b. A second wheel arrangement 15 comprises the second RH wheel 15a and the second LH wheel 15b. A third wheel arrangement 17 comprises the third RH wheel 17a and the third LH wheel 17b. The average distance between two different wheel arrangements can be controlled to cause the pivot mechanism 24 to pitch about the point of the pivot mechanism 24 which enables the climbing robot 10 to overcome obstacles.

The average distance between the first wheel and the second wheel arrangement 13, 15 is equal to half of: a) the distance between the first RH wheel 13a and the second RH wheel 15a; plus, b) the distance between the first LH wheel 13b and the second LH wheel 15b. The average distance between the second wheel arrangement 15 and the third wheel arrangement 17 is equal to half of: a) the distance between the second RH wheel 15a and the third RH wheel 17a; plus, b) the distance between the second LH wheel 15b and the third LH wheel 17b.

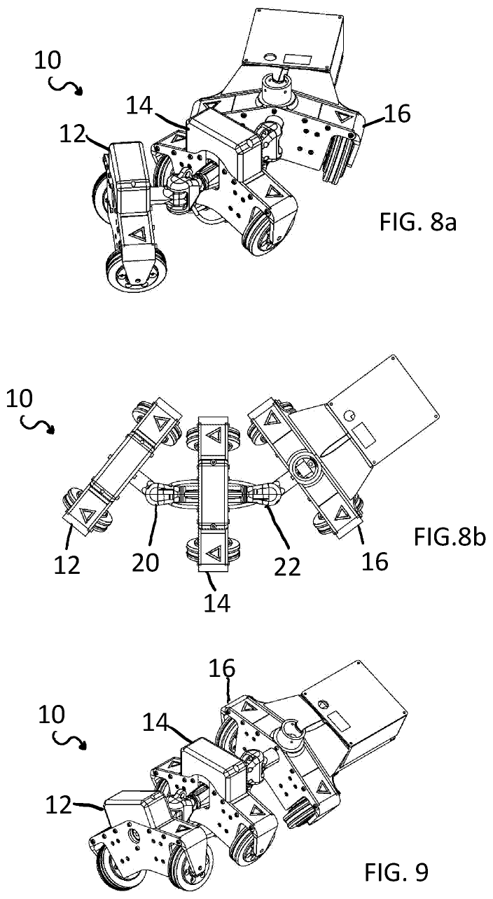

For example, if the second RH and LH wheels 15a, 15b are aligned with the third RH and LH wheels 17a, 17b, the average distance between the second and third wheel arrangements 15, 17 is equal to the distance between the second RH wheel 15a and the third RH wheel 17a (which is also equal to the distance between the second LH wheel 15b and the third LH wheel 17b). It is noted that the second RH and LH wheels 15a, 15b may not be aligned with the third RH and LH wheels 17a, 17b if the climbing robot 10 is in the middle of a right turn manoeuvre as shown in FIG. 8a, 8b (i.e., the distance between the second RH wheel 15a and the third RH wheel 17a is less than the distance between the second LH wheel 15b and the third LH wheel 17b).

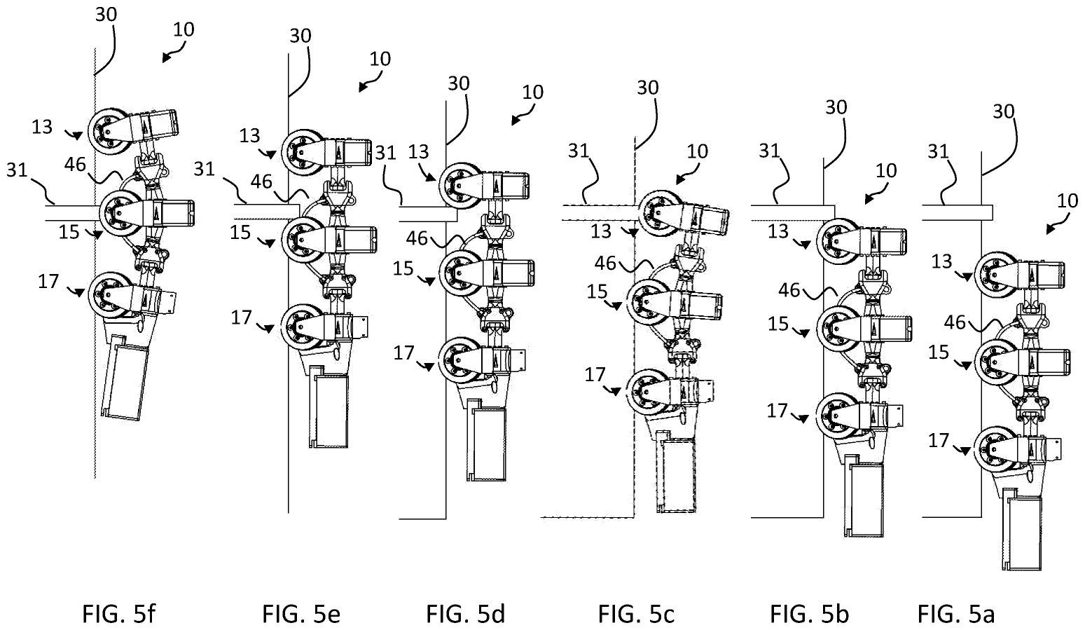

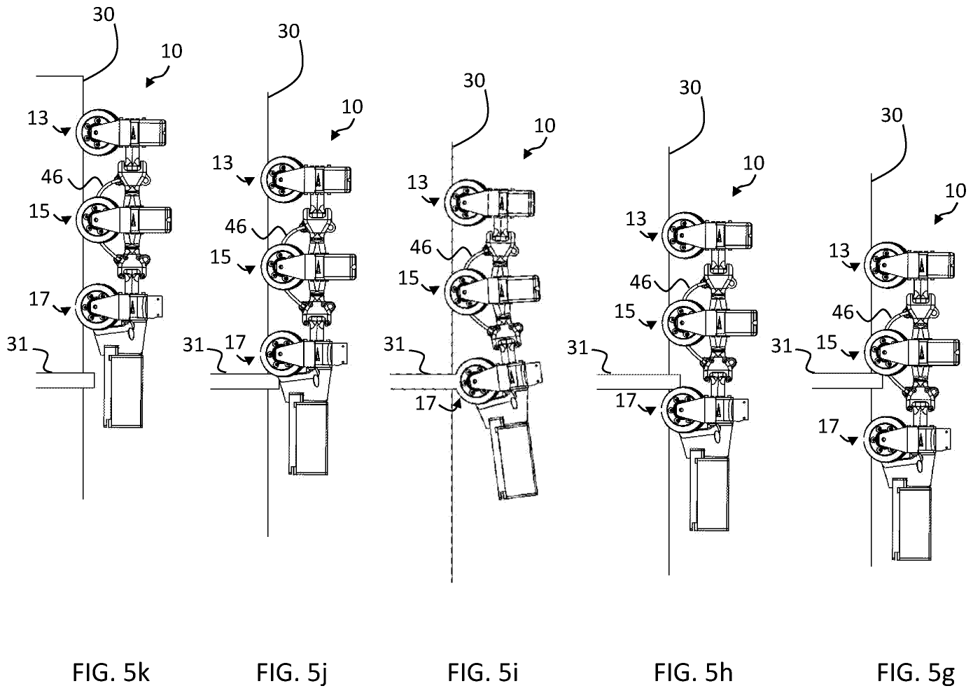

FIGS. 5a-5k demonstrate the climbing robot 10 climbing a surface of a ferrous tower 30 and overcoming a non-ferrous step or obstacle 31 (e.g., bands which are commonly found on real world structures to attach signage or external cabling) on the ferrous tower 30, while moving along the axis of the ferrous tower 30.

When ascending a ferrous tower, a centre of mass of the climbing robot 10 which is towards the ground and close to the ferrous tower surface passively enable stability (individually or in combination). Therefore, the centre of mass of the climbing robot 10 is off-centre and towards the third drive unit 16, i.e., towards the closest point to the ground/base of the ferrous tower when in use. This passively assists in maintaining adhesion to the ferrous tower and reduces the risk of wheel slippage. The third drive unit 16 comprises the power source and any shared hardware in a storage pack 18 and the weight of this storage pack 18 ensures that the centre of mass of the climbing robot 10 is off-centre. Other design choices may be made which can achieve the same effect. The storage pack 18 can alternatively be coupled to the third drive unit 16 via a hinge mechanism (or other known coupler) so that it does not impede the motion of the movement of the climbing robot 10.

FIGS. 5a and 5b show the climbing robot 10 approaching the obstacle 31. To raise the first drive unit 12 to overcome the obstacle 31, the controller can either:
operate the wheel arrangements 13, 15, 17 to drive into the obstacle. As the first wheel arrangement 13 contacts the obstacle 31, the obstacle 31 forces the first wheel arrangement 13 from the surface of the ferrous tower 30 and onto the obstacle 31. Optionally the first wheel arrangement 13 may rotate its wheels 13a, 13b to aid in overcoming the obstacle 31. The pivot mechanism 24 allows the first drive unit 12 to drive over the obstacle 31 while the remaining wheel arrangements 15, 17 of the climbing robot 10 remain adhered to the surface of the ferrous tower 30. The pivot mechanism 24 operates passively and in response to the pivoting of the first and third drive units 12, 16 with respect to each other about the point of the pivot mechanism 24 (caused by the first drive unit driving over the obstacle 31 while the third drive unit is adhered to the surface of the ferrous tower 30), the average distance between the first and second wheel arrangements increase.
operate at least the second wheel arrangement 15 and the third wheel arrangement 17 to actively lift the first wheel arrangement 13. The third wheel arrangement 17 is braked while the second wheel arrangement 15 rotates to increase the average distance between the second and third wheel arrangements 15, 17. That is, the second wheel arrangement is “over driven” to allow the first drive unit 12 to lift relative to the second and third drive units 14, 16. In addition, the first drive unit 12 may climb the obstacle using the combined grip of the entire climbing robot 10.

The increase in the average distance between the second and third wheel arrangements 15, 17 causes the first and third drive units 12, 16 to move with respect to each other about the point of the pivot mechanism 24 by an angle, due to the mechanical arrangement of the pivot mechanism 24, and thus the first drive unit 12 lifts from the surface of the ferrous tower 30. In addition, the first drive unit 12 lifting from the surface of the ferrous tower 30 also causes the average distance between the second and third wheel arrangements 15, 17 (and also the first and second wheel arrangements 13, 15) to increase, due to the mechanical arrangement of the pivot mechanism 24.

The angle may be proportional to the average distance between the second and third wheel arrangements 15, 17. The angle is enough for the first drive unit 12 to overcome the obstacle 31. The presence of the non-ferrous obstacle 31 may assist in de-adhering the first drive unit 12 with or without controlling the first RH and LH wheels 13a, 13b of the first drive unit 12.

To actively increase the average distance between the second and third wheel arrangements 15, 17 the controller can:
brake the third RH and LH wheels 17a, 17b and drive forward the second RH and LH wheels 15a, 15b, or vice versa; or,
drive the third RH and LH wheels 17a, 17b and drive the second RH and LH wheels 15a, 15b by different rotational angles (or speeds) so to increase the relative average distance between the second and third wheel arrangements 15, 17.

In an alternative example, the wheels 15a, 15b of the second drive unit 14 and the wheels 17a, 17b of the third drive unit 16 may be of different sizes, the controller may drive the wheels 17a, 17b of the third drive unit 16 and drive the wheels 15a, 15b of the second drive unit 14 by identical rotational angles to achieve the same effect.

FIG. 5c shows the climbing robot 10 with the first drive unit 12 resting on the obstacle 31. An optional elastic material 46 (e.g., extension springs, torsional springs, elastic cord, spring steel, etc.) may be present between the first and third drive units 12, 16 to supply a constant counter rotational force at the point of the pivot mechanism 24. This counter rotational force biases the first and third drive units 12, 16, towards the surface of the ferrous tower 30. The use of an elastic material 46 in this way provides a passive restoration-force which can bias the first drive unit 12 to the surface of the obstacle 31.

FIG. 5d shows the climbing robot 10 with the first drive unit 12 having overcome the obstacle 31 and re-adhering to the ferrous tower 30. The front drive unit 12 may be re-adhered to the surface of the ferrous tower 30 by performing the opposite actions to those shown in FIGS. 5a and 5b. Passive force provided by the optional elastic material 46 can help to reattach and restore adhesion of the first drive unit 12 to the surface of the ferrous tower 30 as the first drive unit 12 passes the obstacle 31.

FIG. 5e shows the second drive unit 14 of the climbing robot 10 approaching the obstacle 31. To raise the second drive unit 14 to overcome the obstacle 31 the controller can control at least the first wheel arrangement 13, and the third wheel arrangement 17, to decrease the average distance between the first and third wheel arrangements 13, 17. Alternatively, the obstacle 31 raises the second drive unit 14 over the obstacle 31 due to the first and third wheel arrangements 13, 17 driving the climbing robot 10 forward and into the obstacle 31. The pivot mechanism 24 passively adapts the robot to conform to the changing climbing surface of the ferrous tower 30.

The decrease in the average distance between the first and third wheel arrangements 13, 17 causes the first and third drive units 12, 16 to move with respect to each other about the point of the pivot mechanism 24 by an angle, due to the arrangement of the pivot mechanism 24, and thus the second drive unit 14 lifts from the surface of the ferrous tower 30.

The angle can be proportional to the average distance between the first and third wheel arrangements 13, 17. The angle is enough for the second drive unit 14 to overcome the obstacle 31. The presence of the non-ferrous obstacle 31 may assist in de-adhering the wheels of the second drive unit 14 with or without controlling the wheels 15a, 15b of the second drive unit 14.

FIG. 5f shows the second drive unit 14 resting on the obstacle 31. Optionally, a second elastic material (similar to the elastic material 46 as shown in FIGS. 5c and 5d) is present (between the first and third drive units 12, 16) which can supply a counter rotational force at the point of the pivot mechanism 24 to bias the second drive units 14 towards the surface of the obstacle 31.

FIG. 5g shows the climbing robot 10 with the second drive unit 14 having overcome the obstacle 31 and re-adhering to the ferrous tower 30. The second drive unit 14 can be re-adhered to the surface of the ferrous tower 30 by performing the opposite actions to those explained above with respect to FIG. 5e. Additionally, or alternatively, the second elastic material may be present. The use of the second elastic material in this way provides a passive restoration-force which can reattach and restore adhesion of the second drive unit 14 to the surface of the ferrous tower 30 as the second drive unit 14 passes the obstacle 31.

FIGS. 5h to 5k show the third drive unit 16 approaching and overcoming the obstacle 31 in a similar way as shown in FIGS. 5a to 5d.

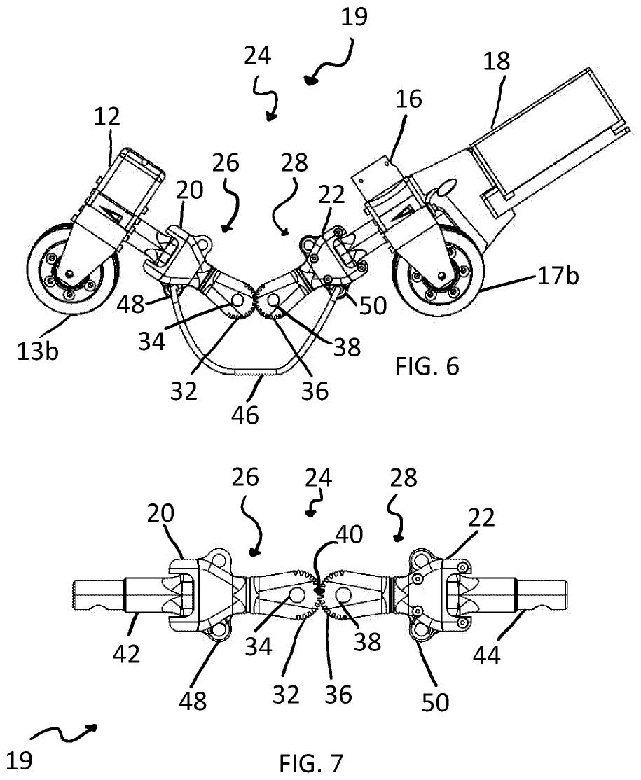

FIG. 6 shows the climbing robot 10 without the second drive unit 14 so the 5DOF linkage 19 can be seen. FIG. 7 shows the 5DOF linkage 19.

The 5DOF linkage 19 comprises the pivot mechanism 24 (as shown in FIGS. 3 and 4), a first link 42, and a second link 44. The pivot mechanism shown in FIGS. 6 and 7 is a dual gear pivot mechanism 24. The dual gear pivot mechanism 24 comprises a first arm 26 and a second arm 28. The first arm 26 comprises a first partially-circular (i.e. arc-shaped) element 32 at a distal end which rotates about a first pivot point 34, and a first coupling end 20 configured to couple to a first drive unit 12 via the first link 42. The second arm 28 comprises a second partially-circular (i.e. arc-shaped) element 36 at a distal end which rotates about a second pivot point 38, and a second coupling end 22 configured to couple to a third drive unit 16 via the second link 44. Partially-circular can be equivalent to a semi-circular shape with more or less than 180 degrees.

The first partially-circular element 32 and the second partially-circular element 36 are arranged to connect with each other to form a pitch point 40 and each comprise a respective pivot point 34, 38. The first and second arms 26, 28 are arranged to pivot about the respective pivot points 34, 38. Both pivot points 34, 38, are coupled to the second drive unit 14 of a climbing robot 10 such that the first and second pivot points 34, 38 are fixed relative to each other, and the second drive unit 14. This arrangement allows the relative distance between different wheel arrangements to cause the first and second partially-circular elements 32, 36 to move about each other at the pitch point 40,0 which causes the first and third drive units 12, 16 to move with respect to each other about the pitch point 40 of the dual gear pivot mechanism 24 by an angle.

The first and second arms 26, 28 are arranged to move about the pitch point 40 symmetrically. This enables improved manoeuvrability by maximising the range of motion of the pitch point 40. As the first and third drive units 12, 16 move in tandem, the maximum lift possible of the first drive unit 12 is doubled.

The first partially-circular element 32 may have gear-like teeth arranged to engage with respective gear-like teeth of the second partially-circular element 36 in order to connect with each other at a pitch point 40. Alternatively, the first partially-circular element 32 may be coated in a rubber material arranged to engage with respective rubber material of the second partially-circular element 36 in order to connect with each other at a pitch point. Other means of connecting the first partially-circular element 32 and the second partially-circular element 36 may be used, as long as such other means allow for the required pivoting.

The 5DOF linkage 19 is unpowered (i.e., passive). The independent control of the first, second, and third RH and LH wheels 13a, 13b, 15a, 15b, 17a, 17b enables the wide variety of movements shown in FIGS. 3, 4, 8a to 10b. In particular, FIGS. 3 and 4, 5a-k, show the ability of the climbing robot 10 to pitch about the point of the pivot mechanism which enables the climbing robot 10 to overcome obstacles. FIGS. 8a and 8b show the ability of the climbing robot 10 to turn. FIG. 9 shows the ability of the climbing robot 10 to twist in order to conform to an uneven or curved surface.

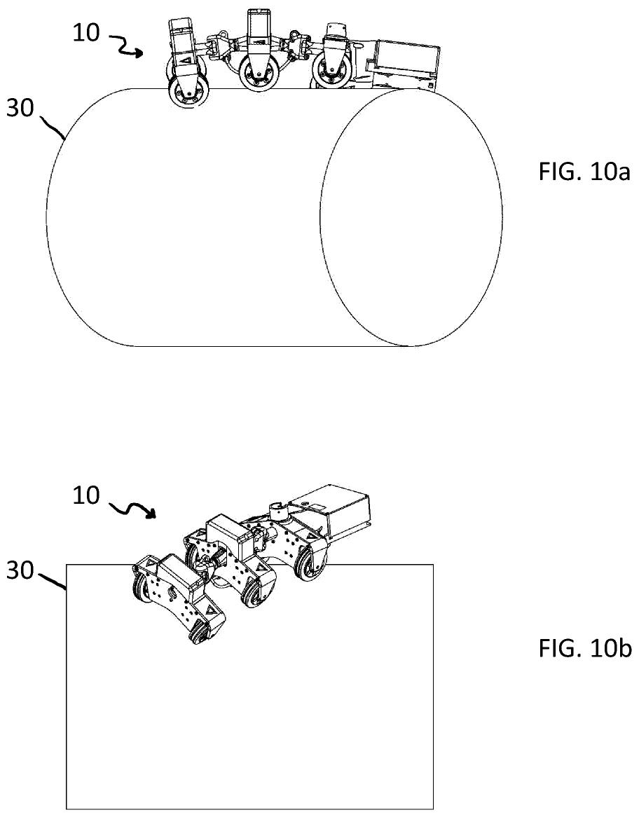

FIGS. 10a and 10b show the climbing robot 10 adhering to a ferrous tower 30 while conforming to the surface of the ferrous tower 30.

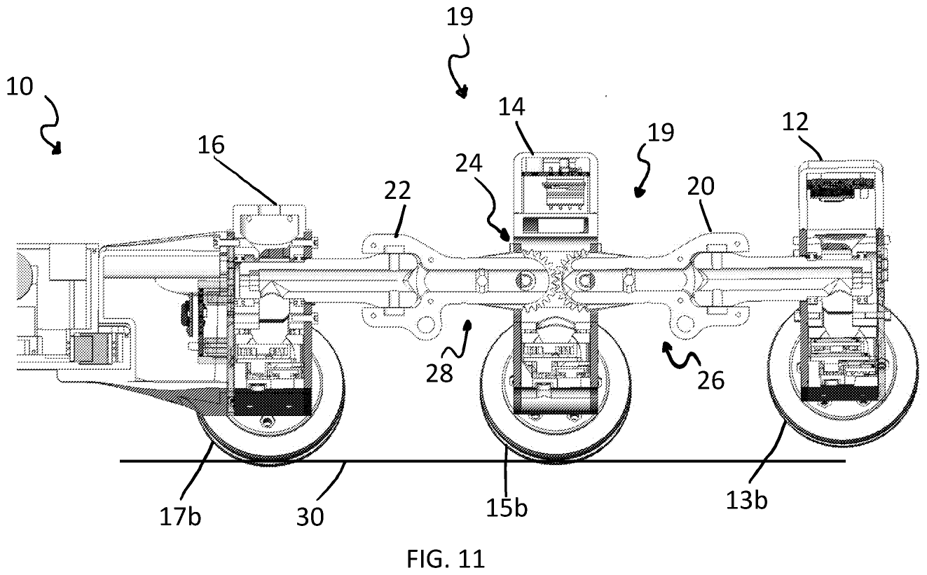

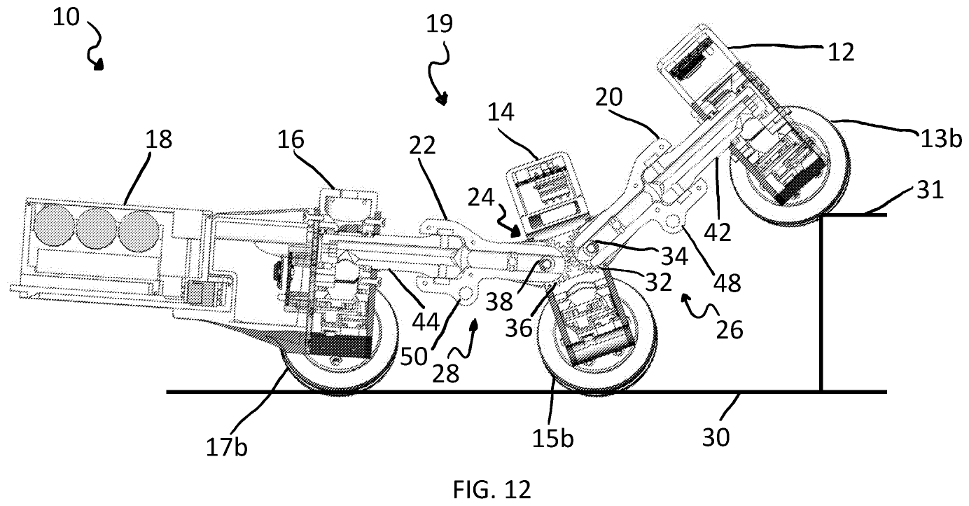

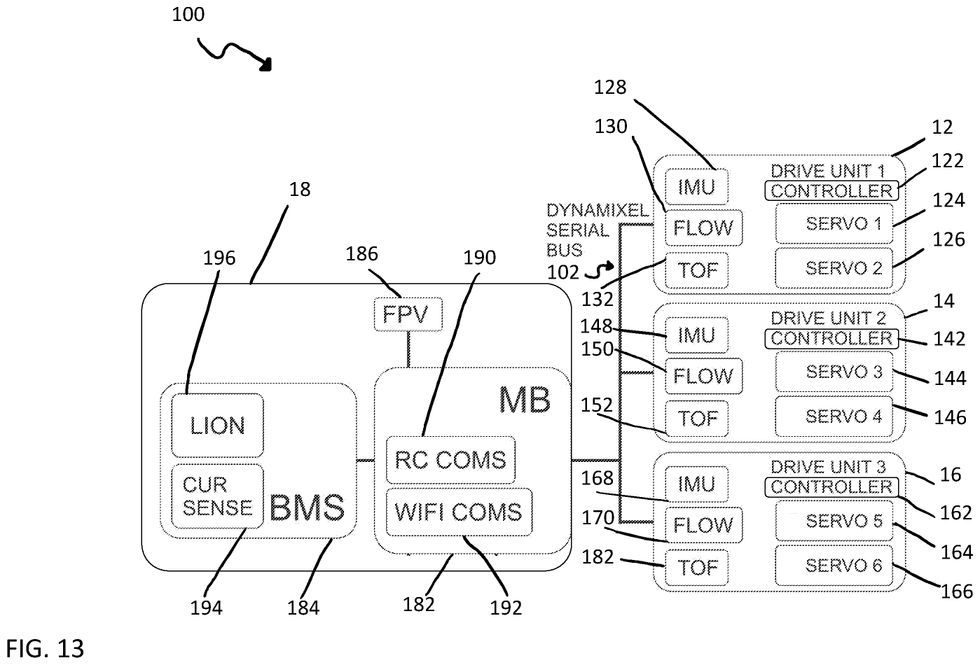

FIGS. 11 and 12 show a cross section of the climbing robot 10. The first coupling end 20 is arranged to connect the first link 42 to the dual gear pivot mechanism 24 with one degree of freedom: yaw. The first coupling end 20 allows the first and second drive units 12, 14 to turn (i.e., yaw) with respect to each other. The second coupling end 22 is arranged to connect the second link 44 to the dual gear pivot mechanism 24 with one degree of freedom: yaw. The second coupling end 22 allows the second and third drive units 14, 16 to turn (i.e., yaw) with respect to each other as shown in FIGS. 8a and 8b. This allows the climbing robot 10 to change its path on the ferrous tower 30 to avoid obstacles or direct itself to a destination. In order to turn, the controller of the climbing robot 10 can control relative rotation of the RH and LH wheels of one of the first, second, and third drive units 12, 14, 16 independently. For example, the climbing robot 10 can turn to the right (e.g., see FIGS. 8a and 8b) if the first RH wheel 13a brakes and the first LH wheel 13b rotates. The skilled person would understand that many other ways of controlling the first, second, and third RH and LH wheels 13a, 13b, 15a, 15b, 17a, 17b, are possible to achieve a turning effect.

The first link 42 is arranged to couple to the first drive unit 12 via a bearing or other means with one degree of freedom: roll. This allows the first drive units 12 to rotate about an axis of the first link 42 (as shown in FIG. 9). The second link 44 is arranged to couple to the third drive unit 16 via a bearing or other means with one degree of freedom: roll. This allows the third drive units 16 to rotate about an axis of the second link 44. Therefore, the first and third drive units 12, 16 can independently (and passively) rotate with respect to the second drive unit 14. This enables the climbing robot 10 to maintain its connection to the ferrous tower 30 surface by conforming to the surface, which is particularly important feature for climbing ferrous towers 30 because it is desirable to maintain maximum adherence to the surface as much as possible. This is shown in FIGS. 10a and 10b.

The elastic material 46 (as shown in FIGS. 5d and 5g) is shown to attach to a first connection point 48 on the first coupling end 20 and a second connection point 50 on the second coupling end 22, and passing across the pivot mechanism 24 by passing through or around the second drive unit 14. The elastic material 46 is shown in FIG. 6 as passing below the pitch point 40, however, a second elastic material (not shown) can alternatively or additionally pass above the pitch point 40 to provide a rotational counter force which biases the second drive unit 14 towards the climbing surface 30.

FIG. 11 shows the 5DOF linkage 19 and the first, second, and third drive units 12, 14, 16 connected together. The first partially-circular element 32 has gear-like teeth arranged to engage with respective gear-like teeth of the second partially-circular element 36 in order to connect with each other at a pitch point 40. Both first and second pivot points 34, 38, are coupled to the second drive unit 14 of a climbing robot 10 such that the first and second pivot points 34, 38 are fixed relative to each other, and the second drive unit 14.

FIG. 12 shows second LH wheel 15b after being controlled to increase its distance from first LH wheel 13b. This causes the second drive unit 14 to pivot about the second pivot point 38 with respect to the second arm 28 (connected to the third drive unit 16) by an angle, x, which causes the pitch point 40 to move relative to the second partially-circular element 36 and the first partially-circular element 32, which causes the first arm 26 28 (connected to the first drive unit 12) to pivot about the first pivot point 34 relative to the second drive unit 14 by the angle, x.

FIG. 13 shows a block diagram 100 showing an example computer system which can be used to control the climbing robot 10 and upon which any one or more of the methodologies herein discussed can be operated.

The block diagram 100 shows the first drive unit 12, the second drive unit 14, the third drive unit 16, and the optional storage pack 18 joined together with a cable 102. The cable 102 can comprising a voltage (V+) conductor, a voltage negative (V− or ground) conductor, and a communications conductor. The cable 102 can transmit and receive power and data. The cable 102 can be a ‘Dynamixel Serial Bus’ cable 102. The cable 102 can comprise of multiple communications conductors.

The first drive unit 12 comprises a first controller 122, a first RH wheel servo (SERVO 1) 124, a second LH wheel servo (SERVO 2) 126, a first inertial measurement unit (IMU) 128, a first optical flow camera sensor (FLOW) 130, and a first time of flight sensor (TOF) 132. The first controller 122 may communicate data and/or power to components of the first drive unit 12, and/or communicate data and/or power to other units of the climbing robot 10.

The second drive unit 14 comprises a second controller 142, a second RH wheel servo (SERVO 3) 144, a second LH wheel servo (SERVO 4) 146, a second inertial measurement unit (IMU) 148, a second optical flow camera sensor (FLOW) 150, and a second time of flight sensor (TOF) 152. The second controller 142 may communicate data and/or power to components of the second drive unit 14, and/or communicate data and/or power to other units of the climbing robot 10

The third drive unit 16 comprises a third controller 162, a third RH wheel servo (SERVO 5) 164, a third LH wheel servo (SERVO 6) 166, a third inertial measurement unit (IMU) 168, a third optical flow camera sensor (FLOW) 170, and a third time of flight sensor (TOF) 172. The third controller 162 may communicate data and/or power to components of the third drive unit 16, and/or communicate data and/or power to other units of the climbing robot 10.

The (optional) storage pack 18 comprises a mother board (MB) controller 182, a battery management system (BMS) 184, and a First Person View video transmission unit (FPV) 186.

Each of the first, second, and third IMUs 128, 148, 168 are optional. Each IMU 128, 148, 168 measures the specific forces of its respective drive unit 12, 14, 16. The specific forces can be used to calculate orientation of the respective drive unit 12, 14, 16. As an example which can apply to all drive units, the first IMU 128 of the first drive unit 12 can send data to the first controller 122 to calculate orientation information. The calculated orientation information can be used by the first controller 122 to control the first RH, LH wheels 13a, 13b via their respective servos 124, 126, e.g., in a control loop. The control loop can ensure that the first drive unit 12 is in an expected location/orientation and can be used to track the location/orientation of the first drive unit 12. The control loop can ensure that the first drive unit 12 compensates for wheel slippage or other physical force interacting with the first drive unit 12. This enables the servos 124, 126 to accurately drive each of the first RH, LH wheels 13a, 13b, to move the first drive unit 12 to a desired location/orientation. Alternatively, or additionally, the first drive unit 12 may comprise a wheel encoder, which can be used to track wheel movement, and thus the location/orientation of the first drive unit 12. This enables the first RH, LH servos 124, 126 to drive each of the first RH, LH wheels 13a, 13b, to move the first drive unit 12 to a desired location/orientation. In another alternative example, the climbing robot 10 may not comprise a IMU or wheel encoder, or a IMU and/or a wheel encoder may be present in only a subset of the first, second, and third drive units 12, 14, 16.

Each of the first, second, and third FLOW sensors 130, 150, 170 are optional. Each FLOW sensor 130, 150, 170 measures the displacement of the respective drive unit 12, 14, 16. As an example which can apply to all drive units, the first FLOW sensor 130 can measure the displacement of the first drive unit 12 and reports to the first controller 122 the distance the first drive unit 12 has moved. The displacement information can be used by the first controller 122 to control the first RH, LH wheels 13a, 13b via their respective first RH, LH servos 124, 126, e.g., in a control loop. The control loop can ensure that the first drive unit 12 is in an expected location/orientation and can be used to track the location/orientation of the first drive unit 12. The control loop can ensure that the first drive unit 12 compensates for wheel slippage or other physical force interacting with the first drive unit 12. In another alternative example, the climbing robot 10 may not comprise a FLOW sensor, or a FLOW sensor may be present in only a subset of the first, second, and third drive units 12, 14, 16.

Each of the first, second, and third TOF sensors 132, 152, 172 are optional. Each TOF sensor 132, 152, 172 measures the distance from the respective drive unit 12, 14, 16 to a climbing surface. As an example which can apply to all drive units, the first TOF sensor 132 can detect if the first drive unit 12 has detached from the climbing surface so that the climbing robot 10 can take corrective measures through control of one or more of the wheels 13a, 13b, 15a, 15b, 17a, 17b of the climbing robot 10. In another alternative example, the climbing robot 10 may not comprise a TOF sensor, or a TOF sensor may be present in only a subset of the first, second, and third drive units 12, 14, 16. In an alternative example, an IMU (instead of a TOF) may be used to detect if the first drive unit 12 has detached from the climbing surface. In an alternative example, no sensor is necessary to detect if the first drive unit 12 has detached from the climbing surface.

The MB controller 182 comprises a Radio control communication subsystem (RC COMS) 190, and WiFi communication subsystem (WIFI COMS) 192.

The RC COMS 190 can be configured to receive driving instructions from a remote controller (not shown). The driving instructions are interpreted by the MB controller 182 and sent to the appropriate first, second, and/or third controller 122, 142, 162 to perform the driving instructions.

The WIFI COMS 192 can be configured to enable a wireless communication link from the climbing robot 10 to one of: a remote controller, or an external storage device. The WIFI COMS 192 can transmit data from the climbing robot 10, for example, the data may be from the FPV 186 and transmitted to a remote controller, and/or data may be from any of the on-board sensors for monitoring purposes at the remote controller. In an alternative embodiment, any wireless or wired data carrying method may be used instead of WiFi.

The FPV 186 comprises a camera and can communicate with the MB controller 182 to send visual image data to a remote controller via WIFI COMS 192. The FPV 186 enables a user to view from the perspective of the climbing robot 10. This can aid in navigating the climbing robot 10, and the received images can be recorded on a storage device.

The BMS 184 comprises a lithium-ion battery (LION) 196 and a current sensor (CUR SENSE) 194. The LION 196 is preferred for is power density characteristics and is used to power the climbing robot 10. The current sensor 194 enables the MB controller 182 to monitor the LION 196, specifically during charging and discharging, so that the LION 196 can operate within its operating parameters.

Optionally, the climbing robot 10 may further comprise a turret (not shown). The turret may be independently operated. The turret may comprise the FPV 186 to enable an extended field of view. The turret may also comprise tools for repairs to be carried out in the field, i.e., on a ferrous tower. The turret may also comprise any elements of the system 100.

The cable 102 is optional. In an alternative embodiment, the climbing robot 10 may not comprise a cable 102. For example, the first, second, and third drive unit may comprise their own independent systems such as BMS 184 and wireless communications units 190, 192. Moreover, only one of the first, second, and third drive units may comprise the FPV 186.

As shown in FIG. 13, each wheel is coupled to a servo 124, 126, 144, 146, 164, 166. In an alternative embodiment other motor technologies may be used instead of a servo.

As shown in FIG. 13, a MB controller 182 is in communication with first, second, and third controllers 122, 142, 162. However, in an alternative embodiment, the climbing robot 10 may comprise only a single controller.

As shown in FIG. 13, a MB controller 182 comprises the optional RC COMS 190, however, in an alternative example, the climbing robot 10 is fully autonomous and does not require the RC COMS 190 to receive drive instructions.

As shown in FIG. 13, a MB controller 182 comprises the optional WIFI COMS 192, however, in an alternative example, the climbing robot 10 does not need to transmit data from the climbing robot 10. Instead the climbing robot 10 may comprise and internal storage device to store any collected data.

Components of the storage unit 18 may be distributed between the first, second, and third drive units 12, 14, 16. In an alternative example, the climbing robot may not comprise a storage unit 18.

The BMS 184 is optional. In an alternative embodiment, the climbing robot 10 is powered by a cable connection to an external power supply.

The LION 196 is optional. In an alternative embodiment, the climbing robot 10 may comprise any other type of power storage technology.

The FPV 186 is optional. In an alternative embodiment, the climbing robot 10 may autonomously controlled or can be remotely operated via a line of sight.

It is described at FIGS. 1 and 2 that each wheel of the climbing robot 10 is configured to magnetically adhere to a ferrous structure by permanent magnets located in the wheels. However, in an alternative example, any adherence means, such as, permanent magnets, electromagnets, negative pressure mechanisms using vacuum pumps and suction cups, and electro-adhesion (such as, electrostatic induction), or a combination of any of the above means can be used.

In an alternative example, each of the first, second, and third drive units 12, 14, 16 may comprise at least one wheel. Each wheel can comprise a respective servo, independent of the number of wheels per wheel arrangement of a drive unit. For example, a single wheel (e.g., a wide wheel with a relatively high width to high ratio, e.g., 1:1—to increase adhesion to a surface) per each drive unit may be sufficient depending on the use-case of the climbing robot, although such an example would not be able to steer/turn with independent control of the wheels. In another example, the first and third drive units 12, 16 may comprise two or more wheels to enable the climbing robot to steer/turn, and the second drive unit 14 can comprise a single wheel (e.g., a wide wheel with a relatively high width to high ratio, e.g., 1:1—to increase adhesion to a surface). In another example, the second drive 14 unit may comprise two or more wheels to enable the climbing robot to steer/turn, and the first and third drive units 12, 16 can comprise a single wheel (e.g., a wide wheel with a relatively high width to high ratio, e.g., 1:1—to increase adhesion to a surface). If a drive unit only comprises a single wheel, then the single wheel may only be operated to brake or not brake.

In FIGS. 6 and 7, the pivot mechanism 24 is a dual gear pivot mechanism 24. In an alternative example, the pivot mechanism may be another type of pivot mechanism capable of being arranged to, in response to the change in the average distance between the first and second wheel arrangements, cause first and third drive units to move with respect to each other about a point of the pivot mechanism by an angle. Such a pivot mechanism may be implemented with, for example, mechanical linkages and levers.

The elastic material, as shown in FIG. 6, is an example of a passive-type restoration-force arrangement. Additionally or alternatively, the restoration force-arrangement may be either a passive restoration force-arrangement (e.g from material) or an active restoration force-arrangement (e.g from an electro-magnetic actuator).

As shown in FIG. 6, the elastic material 46 is attached at a first connection point on a first coupling end 20 and at a second connection point on a second coupling end 22. The elastic material 46 is also passed through or around the second drive unit 14. In an alternative example, the elastic material 46 (when present) can attach to any other part of the first arm 20 at a first connection point, and any other part of the second arm 22 at a second connection point to achieve the same effect of providing a passive rotational restoring force to the pivot mechanism 24.

The feature: ‘the controller configured to operate two different wheel arrangements to change the average distance between the two different wheel arrangements’, may be functionally equivalent to the feature: ‘the controller configured to operate the wheels of one wheel arrangement, and the wheels of another wheel arrangement, to change the average distance between the respective wheels of the one and the another wheel arrangements’.

In FIGS. 1 to 5k, and 8a to 12, a climbing robot is shown, but the teachings can be applied to a vehicle comprising three drive units, wherein the middle drive unit is coupled to a pivot mechanism. Specifically, the vehicle may comprise three drive units (with independently controllable wheels) connected via a 5DOF linkage 19. Therefore, a vehicle with the features shown in the Figures can be implemented. Certain modifications can be made to the vehicle to adapt it to a landscape, such as: off-road tyres and wheels or other wheels; the centre of mass can be central to the vehicle (or at least more central then the climbing robot 10 shown in the FIGS. 1 to 5k, and 8a to 12); space for a rider or driver; on-board controls instead of a controller; some of the communications and sensors can be removed and other sensors added; and/or other modifications known to the skilled person.

Where the word ‘or’ appears this is to be construed to mean ‘and/or’ (unless the term “and/or” is used specifically) such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

1. A climbing robot for climbing ferrous structures, comprising:
a first drive unit, a second drive unit coupled to a pivot mechanism, and a third drive unit, wherein the second drive unit is coupled to the first and third drive units, wherein each of the first, second, and third drive units comprise a wheel arrangement comprising at least one wheel configured to adhere to a ferrous tower, and each wheel is independently controllable; and,
wherein a first wheel arrangement is the wheel arrangement of one of the first, second, and third drive units, and a second wheel arrangement is the wheel arrangement of another one of the first, second, and third drive units,
wherein the pivot mechanism is arranged to change the average distance between the first and second wheel arrangements in response to movement, about a point of the pivot mechanism by an angle, of the first and third drive units with respect to each other.

2. The climbing robot of claim 1, wherein the pivot mechanism is a dual gear pivot mechanism comprising two partially-circular elements arranged to couple at a pitch point, and the point of the pivot mechanism is the pitch point of the dual gear pivot mechanism.

3. The climbing robot of claim 2, wherein the pivot point of each of the two partially-circular elements is fixed relative to the second drive unit.

4. The climbing robot of claim 1, wherein the first wheel arrangement is the wheel arrangement of one of the first and third drive units, and the second wheel arrangement is the wheel arrangement of the second drive units, wherein the change in the average distance between the first and second wheel arrangements is an increase in the average distance between the first and second wheel arrangements.

5. The climbing robot of claim 4, wherein the first wheel arrangement is the wheel arrangement of the first drive unit, and a third wheel arrangement is the wheel arrangement of the third drive unit,
wherein the pivot mechanism is arranged to decrease the average distance between the first and third wheel arrangements in response to movement about the point of the pivot mechanism by an angle, of the first and third drive units with respect to each other.

6. The climbing robot of claim 1, wherein the first wheel arrangement is the wheel arrangement of the first drive unit, and the second wheel arrangement is the wheel arrangement of the third drive unit, wherein the change in the average distance between the first and second wheel arrangements is a decrease in the average distance between the first and second wheel arrangements.

7. The climbing robot of claim 1, wherein the first drive unit and the second drive unit are coupled in order to allow the first drive unit and the second drive unit to yaw and roll with respect to each other; and,
wherein the second drive unit and the third drive unit are coupled so to allow the second and third drive units to yaw and roll with respect to each other.

8. The climbing robot of claim 1, wherein each wheel arrangement of the first, second, and third drive units comprise two wheels.

9. The climbing robot of claim 1, further comprising a restoration-force arrangement configured to bias at least one of the wheel arrangements to a surface of a ferrous tower, optionally wherein the restoration-force is an elastic material.

10. The climbing robot of claim 9, wherein the restoration-force arrangement is an elastic material which passes across the point of the pivot mechanism.

11. The climbing robot of claim 1, wherein the centre of mass of the climbing robot is off-centre and optionally the third drive unit comprises the power source for the climbing robot.

12. The climbing robot of claim 1, wherein each wheel comprises permanent magnets to adhere to a ferrous structure.

13. The climbing robot of claim 1, wherein the climbing robot further comprises a controller configured to control the wheels of the first wheel arrangement and the wheels of the second wheel arrangement to change the average distance between the first and second wheel arrangements,
wherein the pivot mechanism is arranged to cause the first and third drive units to move with respect to each other about a point of the pivot mechanism by an angle, in response to the change in the average distance between the first and second wheel arrangements.

14. A dual gear pivot mechanism for a climbing robot comprising:
a first arm comprising: a first partially-circular element at a distal end of the first arm, and a first coupling end configured to couple to a first drive unit of a climbing robot; and,
a second arm comprising: a second partially-circular element at a distal end, and a second coupling end configured to couple to a third drive unit of a climbing robot,
wherein the first partially-circular element and the second partially-circular element are arranged to connect with each other to form a pitch point and each comprise a respective pivot point, wherein each pivot point is coupled to a second drive unit of a climbing robot such that the pivot points are fixed relative to each other, wherein the first and second arms are arranged to pivot about the respective pivot points.

15. The dual gear pivot mechanism of claim 14, wherein the first and second arms are arranged to move about the pitch point symmetrically.

16. The dual gear pivot mechanism of claim 14, wherein the first arm further comprises a first connection point arranged to connect to an elastic material, wherein the second arm further comprises a second connection point arranged to connect to the elastic material, wherein the elastic material is coupled between the first and second connection points and arranged to bias the pitch point.

17. A method of controlling a climbing robot for climbing ferrous structures, the climbing robot comprising:
a first drive unit, a second drive unit coupled to a pivot mechanism, and a third drive unit, wherein the second drive unit is coupled to the first and third drive units, wherein each of the first, second, and third drive units comprise a wheel arrangement comprising at least one wheel configured to adhere to a ferrous tower, and each wheel is independently controllable,
the method comprising:
operating a first wheel arrangement and a second wheel arrangement to change the average distance between the first and second wheel arrangements, to cause the first and third drive units to move with respect to each other about a point of the pivot mechanism by an angle, wherein the first wheel arrangement is the wheel arrangement of one of the first, second, and third drive units, and the second wheel arrangement is the wheel arrangement of another one of the first, second, and third drive units.

18. The method of claim 17, wherein each wheel arrangement of the first, second, and third drive units comprise two wheels, the method further comprising:
operating both wheels of one of the first, second, and third drive units independently to turn the climbing robot.
